(19) United States
(12) Patent Application Publication
(10) Pub. No.: US 2025/0026150 A1
(43) Pub. Date: Jan. 23, 2025

(54) SYSTEM AND METHOD FOR PROTECTING A SUPPORT STRUCTURE OF A NON-PNEUMATIC TIRE

(71) Applicant: Bridgestone Bandag, LLC, Nashville, TN (US)

(72) Inventors: Wade L. Terrill, Letts, IA (US); Merle R. Schlapkohl, Durant, IA (US); Alexander G. Tomtschik, Muscatine, IA (US); Chad M. Zeck, Muscatine, IA (US); Terry A. Westway, Conesville, IA (US)

(21) Appl. No.: 18/716,718

(22) PCT Filed: Dec. 14, 2022
(86) PCT No.: PCT/US2022/081490

§ 371 Date: Jun. 5, 2024

Related U.S. Application Data
(60) Provisional application No. 63/295,558, filed on Dec. 31, 2021.

(51) Int. Cl. B60C 7/14; B60C 7/24

(52) U.S. Cl. CPC B60C 7/14; B60C 7/24

(57) ABSTRACT

A method of making a non-pneumatic tire includes providing a non-pneumatic tire structure, and providing a first disk and a second disk. The method further includes securing the first disk to a first side of the non-pneumatic tire structure and securing the second disk to a second side of the non-pneumatic tire structure. The method also includes providing an elastomeric tread circumferentially about a top of the non-pneumatic tire structure and securing a curing envelope about the elastomeric tread. The securing of the curing envelope about the elastomeric tread includes the steps of securing a first end of the curing envelope to the first side of the non-pneumatic tire structure and securing a second end of the curing envelope to the second side of the non-pneumatic tire structure. The method further includes applying heat within the curing envelope.

### FIELD OF INVENTION

The present disclosure relates to a non-pneumatic tire and a system and a method of making the same. More specifically, the present disclosure relates to a system and method of applying a tread to a non-pneumatic tire structure.

### BACKGROUND

Various tire constructions have been developed which enable a tire to run in an uninflated or underinflated condition. Non-pneumatic tires do not require inflation, while “run flat tires” may continue to operate after receiving a puncture and a complete or partial loss of pressurized air, for extended periods of time and at relatively high speeds. Non-pneumatic tires may include a plurality of spokes, a webbing, or other support structure that connects a lower ring to an upper ring. It is known to adhere a pre-cured tread to an upper ring of a non-pneumatic with adhesive or cement.

### SUMMARY OF THE INVENTION

In one embodiment, a method of making a non-pneumatic tire includes providing a tire structure with a lower ring having a first diameter, an upper ring having a second diameter greater than the first diameter—the upper ring being substantially coaxial with the lower ring—and a support structure extending between the lower ring and the upper ring. The method further includes providing a first disk and a second disk. Each of the first and second disks has an upper diameter and a central opening defining a lower diameter. The method also includes securing the first disk to a first side of the tire structure and securing the second disk to a second side of the tire structure. The method further includes providing an elastomeric tread circumferentially about a top of the upper ring, and securing a curing envelope about the elastomeric tread. The securing of the curing envelope about the elastomeric tread includes the steps of securing a first end of the curing envelope to the first side of the tire structure at a location below the support structure and securing a second end of the curing envelope to the second side of the tire structure at a location below the support structure. The method also includes applying heat within the curing envelope.

In another embodiment, a system is provided for assembling a circumferential tread and a non-pneumatic tire structure having an upper ring, a lower ring, and support structure extending between the upper ring and the lower ring. The system includes a curing envelope dimensioned to receive a non-pneumatic tire structure and a circumferential tread, a first disk configured to be secured to a first side of the non-pneumatic tire structure, and a second disk configured to be secured to a second side of the non-pneumatic tire structure. The system also includes a first fastener configured to secure a first side of the curing envelope to the non-pneumatic tire structure, and a second fastener configured to secure a second side of the curing envelope to the non-pneumatic tire structure.

In yet another embodiment, a method of making a non-pneumatic tire includes providing a non-pneumatic tire structure, and providing a first disk and a second disk. The method further includes securing the first disk to a first side of the non-pneumatic tire structure and securing the second disk to a second side of the non-pneumatic tire structure. The method also includes providing an elastomeric tread circumferentially about a top of the non-pneumatic tire structure and securing a curing envelope about the elastomeric tread. The securing of the curing envelope about the elastomeric tread includes the steps of securing a first end of the curing envelope to the first side of the non-pneumatic tire structure and securing a second end of the curing envelope to the second side of the non-pneumatic tire structure. The method further includes applying heat within the curing envelope.

### BRIEF DESCRIPTION OF DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale, and the proportion of certain elements may be exaggerated for the purpose of illustration.

FIG. 1 is a front view of one embodiment of a non-pneumatic tire,

FIG. 2 is a front view of an alternative embodiment of a non-pneumatic tire,

FIG. 3 is a schematic drawing illustrating a perspective view of one embodiment of a curing envelope for a non-pneumatic tire,

FIG. 4 is a schematic drawing illustrating a front view of one embodiment of a protective disk,

FIG. 5 is a schematic drawing illustrating a front view of one embodiment of a protective disk secured to a non-pneumatic tire,

FIG. 6 is a schematic drawing illustrating a front view of one embodiment of a protective disk secured to a non-pneumatic tire and hub assembly, and

FIG. 7 is a front view of one embodiment of an arc band and ratchet assembly.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Axial” and “axially” refer to a direction that is parallel to the axis of rotation of a tire.

“Circumferential” and “circumferentially” refer to a direction extending along the perimeter of the surface of the tread perpendicular to the axial direction.

“Radial” and “radially” refer to a direction perpendicular to the axis of rotation of a tire.

“Tread” as used herein, refers to that portion of the tire that comes into contact with the road or ground under normal inflation and normal load.

While similar terms used in the following descriptions describe common tire components, it should be understood that because the terms carry slightly different connotations, one of ordinary skill in the art would not consider any one of the following terms to be purely interchangeable with another term used to describe a common tire component.

Directions are stated herein with reference to the axis of rotation of the tire. The terms “upward” and “upwardly” refer to a general direction towards the tread of the tire, whereas “downward” and “downwardly” refer to the general direction towards the axis of rotation of the tire. Thus, when relative directional terms such as “upper” and “lower” or “top” and “bottom” are used in connection with an element, the “upper” or “top” element is spaced closer to the tread than the “lower” or “bottom” element. Additionally, when relative directional terms such as “above” or “below” are used in connection with an element, an element that is “above” another element is closer to the tread than the other element.

The terms “inward” and “inwardly” refer to a general direction towards the equatorial plane of the tire, whereas “outward” and “outwardly” refer to a general direction away from the equatorial plane of the tire and towards the sidewall of the tire. Thus, when relative directional terms such as “inner” and “outer” are used in connection with an element, the “inner” element is spaced closer to the equatorial plane of the tire than the “outer” element.

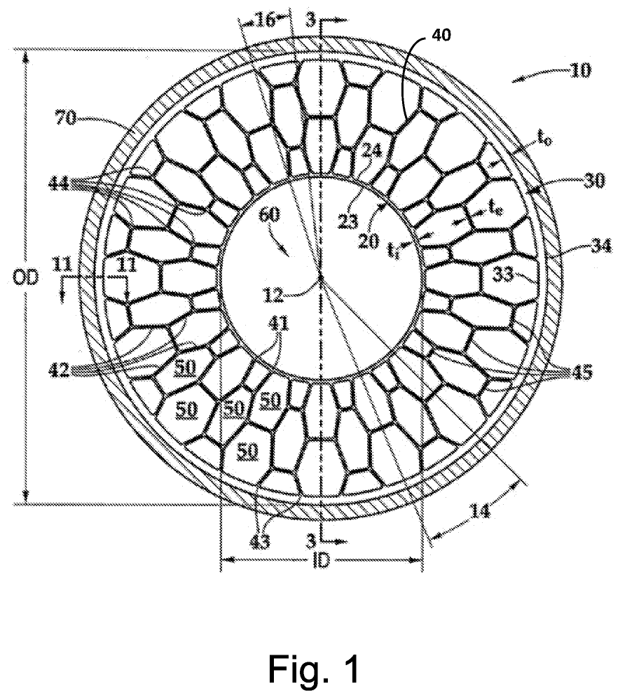

FIG. 1 illustrates one embodiment of a non-pneumatic tire 10. The non-pneumatic tire 10 is merely an exemplary illustration and is not intended to be limiting. In the illustrated embodiment, the non-pneumatic tire 10 includes a generally annular lower ring 20 that engages a rim (not shown) to which the tire 10 is mounted. The generally annular lower ring 20 has an internal surface 23 and an external surface 24 and can be made of an elastomeric material or metal.

The non-pneumatic tire 10 further includes a generally annular upper ring 30 surrounding an interconnected web 40, which is a support structure connected to the generally annular lower ring 20. In alternative embodiments, a plurality of spokes or other support structure connects the lower ring to the upper ring. The upper ring 30 can be configured to deform in an area 48 around and including a footprint region 32, which decreases vibration and increases ride comfort.

In one embodiment, the generally annular lower ring 20 and the generally annular upper ring 30 are made of the same material as interconnected web 40. In one particular embodiment, each of the lower ring 20, upper ring 30, and web 40 are constructed of steel. In alternative embodiments, each of the lower ring 20, upper ring 30, and web 40 are constructed of other metal, carbon fiber, resin, or a polymeric material such as polyurethane, polyester, nylon, or polyvinyl chloride (PVC). It should be understood, however, that other materials may be used and the rings and spokes are not limited to the listed materials.

In an alternative embodiment, at least one of the generally annular lower ring, the generally annular upper ring, and the interconnected web are made of a different material. For example, the upper ring 30 may be a steel band while the lower ring 20 and web 40 are constructed of other metal, carbon fiber, resin, or a polymeric material such as polyurethane, polyester, nylon, or polyvinyl chloride (PVC).

In the illustrated embodiment, the interconnected web 40 has at least two radially adjacent layers 56, 58 of web elements 42 that define a plurality of generally polygonal openings 50. In other embodiments (not shown), other web configurations may be employed.

As shown in FIG. 1, the generally annular upper ring 30 can have a radially external surface 34 to which a circumferential tread 70 is attached. The circumferential tread 70 may be constructed of an elastomeric material, such as natural or synthetic rubber. The tread 70 may have a plurality of circumferential grooves that define a plurality of ribs. It should be understood that the tread may also include tread elements such as lateral grooves, ribs, blocks, lugs, sipes, studs, and other elements. A shear band or other shear element or reinforcement structure (not shown) may be disposed between the upper ring 30 and the tread 70. Alternatively, a shear band or other shear element may be disposed within the tread.

In one embodiment, the circumferential tread 70 is affixed to a top of the upper ring 30, with no pressure-sensitive adhesive disposed between the upper ring 30 and the circumferential tread 70. In one such embodiment, the circumferential tread is 70 bonded directly to the top of the upper ring 30. In another such embodiment, a strip of cured rubber (not shown) or a temperature sensitive adhesive is disposed between the circumferential tread 70 and the upper ring 30.

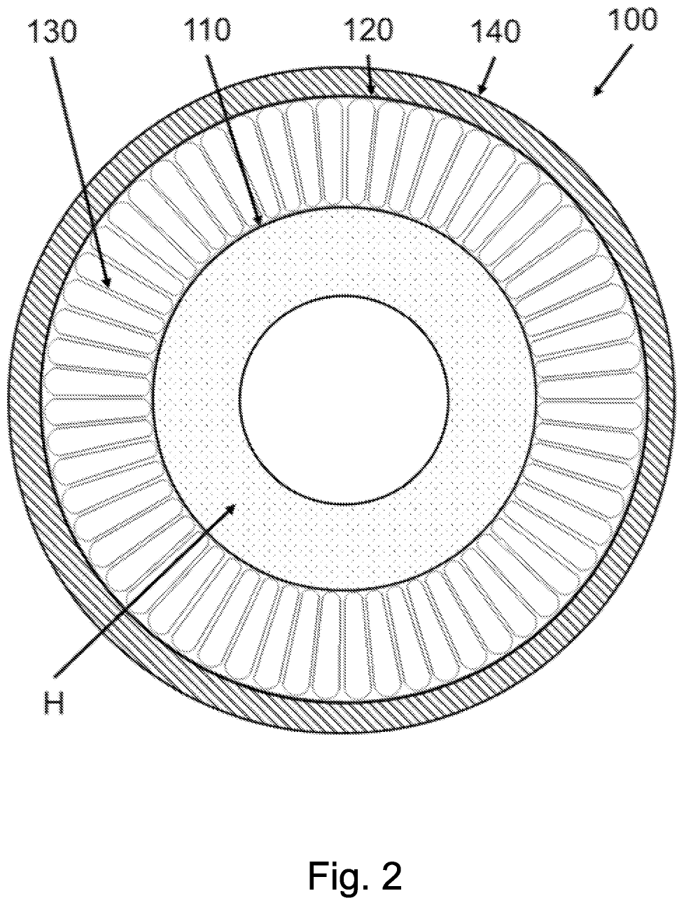

FIG. 2 is a front view of an alternative embodiment of a non-pneumatic tire 100. The non-pneumatic tire 100 includes an inner ring 110 having a first diameter, and an outer ring 120 having a second diameter greater than the first diameter. The outer ring 120 is substantially coaxial with the inner ring 110. In the illustrated embodiment, the inner ring 110 is shown as being attached to a hub H. A plurality of spokes 130 extend between the inner ring 110 and the outer ring 120. It should be understood that the term “support structure” may refer to either webbing (such as the web 40 in FIG. 1) or spokes (such as the spokes 130 in FIG. 2).

In one embodiment, each of the lower ring 110, upper ring 120, and spokes 130 are constructed of the same material. In one particular embodiment, each of the lower ring 110, upper ring 120, and spokes 130 are constructed of steel. In alternative embodiments, each of the lower ring 110, upper ring 120, and spokes 130 are constructed of other metal, carbon fiber, resin, or a polymeric material such as polyurethane, polyester, nylon, or polyvinyl chloride (PVC). It should be understood, however, that other materials may be used and the rings and spokes are not limited to the listed materials.

In an alternative embodiment, one or more of the lower ring 110, upper ring 120, and spokes 130 are constructed of different materials. For example, the upper ring 120 may be a steel band while the lower ring 120 and spokes 130 are constructed of other metal, carbon fiber, resin, or a polymeric material such as polyurethane, polyester, nylon, or polyvinyl chloride (PVC).

A circumferential tread 140 is disposed about the upper ring 120 in the illustrated embodiment. The circumferential tread 140 may be constructed of an elastomeric material, such as natural or synthetic rubber. The tread 140 may have a plurality of circumferential grooves that define a plurality of ribs. It should be understood that the tread may also include tread elements such as lateral grooves, ribs, blocks, lugs, sipes, studs, and other elements. A shear band or other shear element or reinforcement structure (not shown) may be disposed between the upper ring 120 and the tread 140. Alternatively, a shear band or other shear element may be disposed within the tread.

In one embodiment, the circumferential tread 140 is affixed to a top of the upper ring 120, with no pressure-sensitive adhesive disposed between the upper ring 120 and the circumferential tread 140. In one such embodiment, the circumferential tread is 140 bonded directly to the top of the upper ring 120. In another such embodiment, a strip of cured rubber (not shown) or a temperature sensitive adhesive is disposed between the circumferential tread 140 and the upper ring 120.

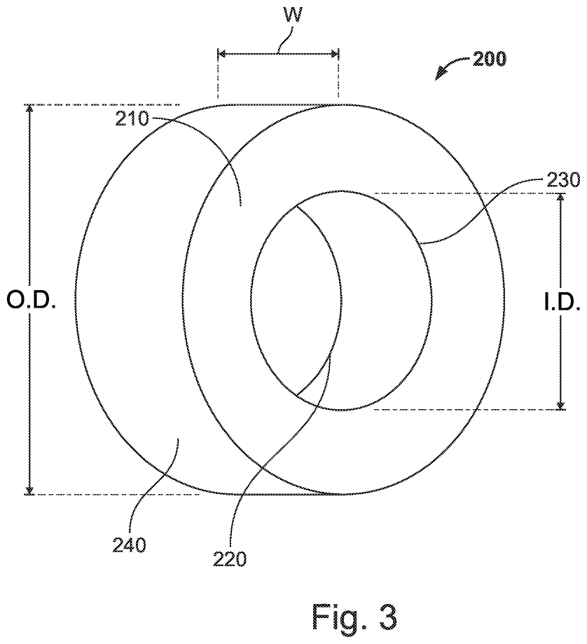

To make a non-pneumatic tire, such as the tire 10 or tire 100, a manufacturer provides a tire structure that includes a lower ring having a first diameter (such as lower ring 20 or lower ring 110), an upper ring having a second diameter greater than the first diameter (such as upper ring 30 or upper ring 120), and a support structure (such as web 40 or spokes 130) extending between the lower ring and the upper ring. The manufacturer also provides an elastomeric tread (such as tread 70 or tread 140) and wraps the tread about the upper ring. The manufacturer secures a curing envelope, such as the curing envelope 200 shown in FIG. 3, about the tire structure and the circumferential tread.

With continued reference to FIG. 3, the curing envelope 200 is dimensioned to receive a circumferential tread and a non-pneumatic tire structure, including the upper ring, the lower ring, and the support structure. The curing envelope 200 has a pair of sides 210, which terminate at a first end 220 and a second end 230. The first and second ends 220, 230 each define an inner diameter ID of the curing envelope 200. The inner diameter ID may be between 9 inches (23 cm) and 24 inches (61 cm). While the sides 210 are shown as being flat, it should be understood that they may be curved or contoured as desired.

The curing envelope also has a top 240 defining an outer diameter OD. The outer diameter OD may be between 28 inches (71 cm) and 60 inches (152 cm). While the top 240 is shown as being flat, it should be understood that it may be curved or contoured as desired. In one embodiment, the sides 210 of the curing envelope 200 have a length between 4 to 51 inches (10 to 130 cm). In other words, the outer diameter OD is 4 to 51 inches greater than the inner diameter ID.

The curing envelope 200 may be a sheet of butyl rubber, other rubber compounds, neoprene, polytene, latex, or other flexible materials. The sheet of material may have a thickness between 0.008 inches (0.02 cm) and 0.12 inches (0.3 cm). The sheet may be damaged or torn by any sharp edges on the support structure of a non-pneumatic tire. Additionally, the sheet may damage the support structures of the non-pneumatic tire. Thus, it is advantageous to employ a protective device for the support structure.

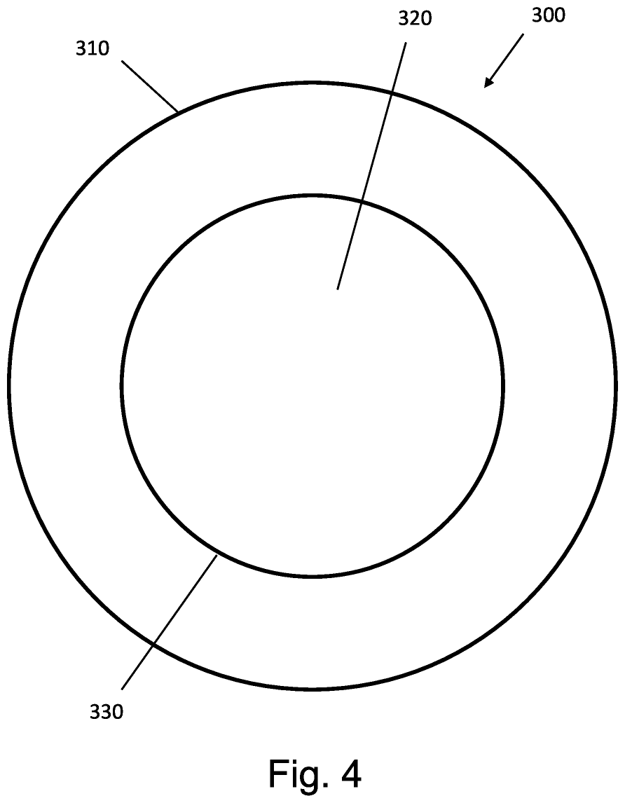

One example of a protective device is a protective disk. FIG. 4 is a schematic drawing illustrating a front view of one embodiment of a protective disk 300. The protective disk 300 has an upper diameter 310 and a central opening 320 defining a lower diameter 330. The protective disk may be constructed of aluminum, carbon fiber, o a polymeric material. Alternatively, the protective disk may be constructed of any material that is sufficiently rigid and able to withstand the heat and pressure applied within the curing envelope.

In one embodiment, the upper diameter 310 of the disk 300 is equal to the first diameter of the upper ring of a non-pneumatic tire structure, and the lower diameter 330 of the disk 300 is equal to the second diameter of the lower ring of a non-pneumatic tire structure. In an alternative embodiment, the upper diameter 310 of the disk 300 may be greater than or less than the first diameter of the upper ring of a non-pneumatic tire structure. Likewise, the lower diameter 330 of the disk 300 may be greater than or less than the second diameter of the lower ring of a non-pneumatic tire structure.

A pair of protective disks may be employed, including a first disk and a second disk. The first disk may be secured to a first side of the tire structure, and the second disk may be secured to a second side of the tire structure. The first and second disks may be secured to the tire structure before the curing envelope is secured to the tire structure. In one embodiment, the upper diameter of the first disk is equal to the upper diameter of the second disk, and the lower diameter of the first disk is equal to the lower diameter of the second disk. In an alternative embodiment, the first and second disks may have different dimensions.

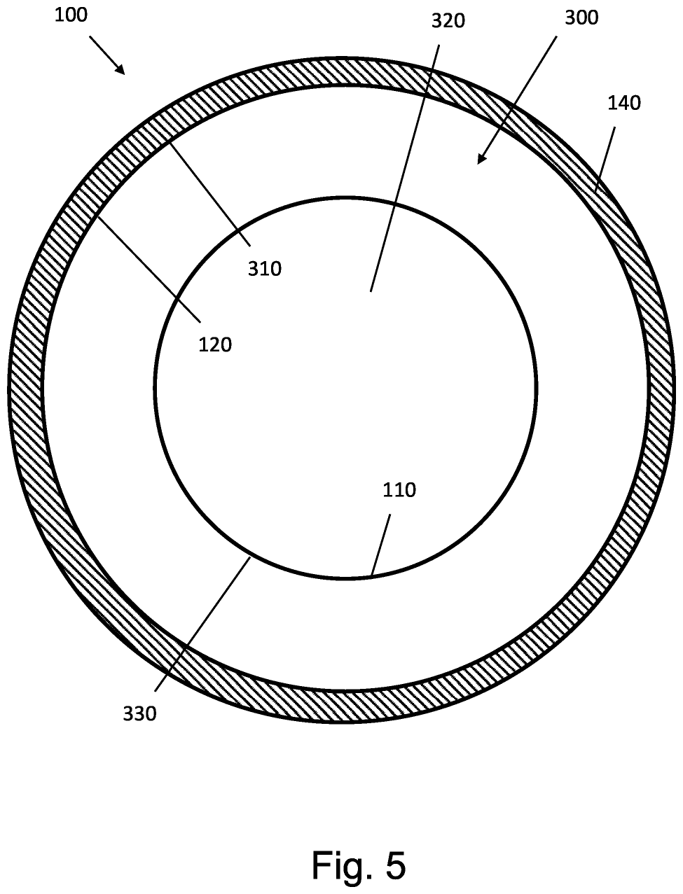

FIG. 5 is a schematic drawing illustrating a front view of the protective disk 300 secured to tire structure of the non-pneumatic tire 100 of FIG. 2. It should be understood, however, that the non-pneumatic tire 100 is merely exemplary and the protective disk 300 may be secured to any non-pneumatic tire structure. While only a single side is shown in FIG. 5, a similar arrangement may be employed on the other side of the tire.

In this example, the protective disk 300 is secured to a side of the tire structure such that the upper diameter 310 of the protective disk 300 abuts the upper ring 120 of the tire structure and the lower diameter 330 of the protective disk 300 abuts the lower ring 110 of the tire structure. Thus, the support structure is not visible. It should be understood, however, that the upper diameter 310 of the protective disk 300 may extend above or below an upper ring of a tire structure. Likewise, the lower diameter 330 of the protective disk 300 may extend above or below a lower ring of a tire structure.

After the protective disks 300 have been secured to the tire structure and a tread 140 has been extended about the upper ring 120 of the tire structure, a first end 220 of the curing envelope 200 may be secured to the first side of the tire structure at a location below the support structure and a second end 230 of the curing envelope 200 may be secured to the second side of the tire structure at a location below the support structure.

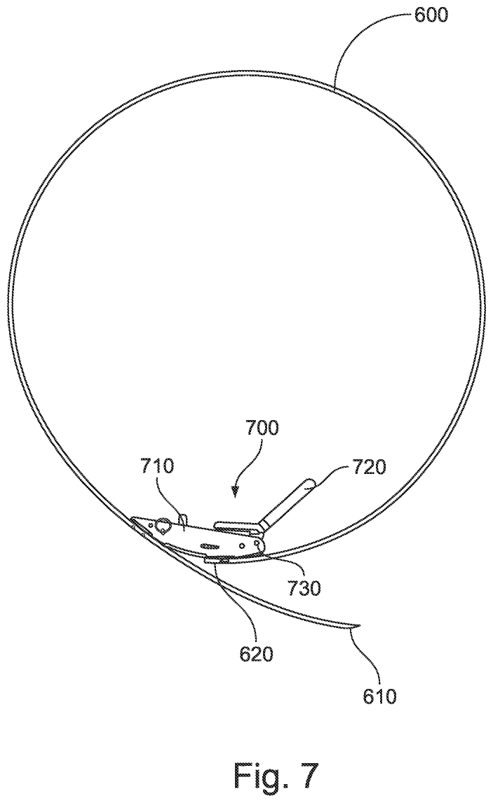

In one embodiment, the securing of the curing envelope 200 about the elastomeric tread and tire structure includes securing each end of the curing envelope with an arc band, such as the arc band 600 shown in FIG. 7. In the illustrated embodiment, the arc band 600 has a first end 610 and a second end 620. A ratchet assembly 700 includes a main body 710 and a handle 720 that is pivotally connected to the main body 710 is connected at a pivot point 730. The main body 710 is connected to the arc band 600 at a first location spaced from the first end 610, and at a second location near the second end 620. The handle 720 can be pivoted between a first and second orientation to change the size of the arc band from a first diameter to a second diameter.

In one embodiment, securing the curing envelope 200 about the elastomeric tread and tire structure includes securing the first end of the curing envelope to a lower surface of the inner ring, and securing a second end of the curing envelope to the lower surface of the inner ring. In an alternative embodiment, securing the curing envelope 200 about the elastomeric tread and tire structure includes securing the first end of the curing envelope to the first disk, and securing a second end of the curing envelope to the second disk.

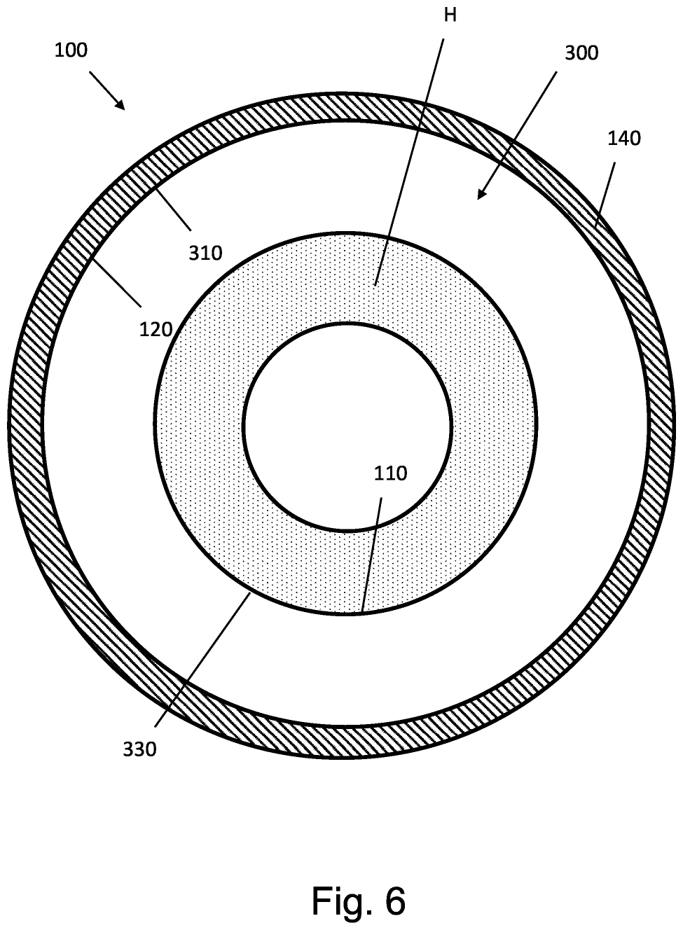

In another alternative embodiment, the tire structure may be mounted on a rim before the protective disks are secured to the tire structure. For example, FIG. 6 is a schematic drawing illustrating a front view of one embodiment of a protective disk 300 secured to a non-pneumatic tire and hub assembly. In this example, the lower ring 110 of the tire structure is mounted to a hub (or rim) H. After the tire structure is mounted to the hub, the protective disk 300 is secured to a side of the tire structure such that the upper diameter 310 of the protective disk 300 abuts the upper ring 120 of the tire structure and the lower diameter 330 of the protective disk 300 abuts the lower ring 110 of the tire structure. Thus, the support structure is not visible. It should be understood, however, that the upper diameter 310 of the protective disk 300 may extend above or below an upper ring of a tire structure. Likewise, the lower diameter 330 of the protective disk 300 may extend above or below a lower ring of a tire structure.

After the protective disks 300 have been secured to the tire structure and a tread 140 has been extended about the upper ring 120 of the tire structure, the first end of the curing envelope is secured to the hub (or rim) H, and the second end of the curing envelope is secured to the hub (or rim) H.

In either embodiment, after the curing envelope is secured to the tire structure, heat and pressure are applied within the curing envelope. In one embodiment, heat is applied at a temperature between 200° F. and 300° F. (90° C. to 150° C.). The elastomeric tread may be a pre-cured or a partially cured tread, having any desired tread elements pre-formed before the tread is provided about the upper ring. Because the elastomeric tread is pre-cured or partially cured, the tread is only heated to a sufficient temperature to bond the tread to the upper ring.

In one embodiment, a strip of green rubber or a temperature sensitive adhesive is first applied to either the tread or the upper ring. In such an embodiment, the applied heat causes the green rubber or the adhesive to bond the tread to the upper ring.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A method of making a non-pneumatic tire, the method comprising:
providing a tire structure including:
a lower ring having a first diameter,
an upper ring having a second diameter greater than the first diameter, the upper ring being substantially coaxial with the lower ring, and
a support structure extending between the lower ring and the upper ring;
providing a first disk and a second disk, each of the first and second disks having an upper diameter and a central opening defining a lower diameter;
securing the first disk to a first side of the tire structure;
securing the second disk to a second side of the tire structure;
providing an elastomeric tread circumferentially about a top of the upper ring;
securing a curing envelope about the elastomeric tread, including the steps of securing a first end of the curing envelope to the first side of the tire structure at a location below the support structure and securing a second end of the curing envelope to the second side of the tire structure at a location below the support structure; and
applying heat within the curing envelope.

2. The method of claim 1, wherein the securing of the curing envelope about the elastomeric tread includes securing each end of the curing envelope with an arc band.

3. The method of claim 1, wherein the securing of the curing envelope about the elastomeric tread includes securing the first end of the curing envelope to a lower surface of the lower ring, and securing a second end of the curing envelope to the lower surface of the lower ring.

4. The method of claim 1, further comprising mounting the tire structure on a rim.

5. The method of claim 4, wherein the securing of the curing envelope about the elastomeric tread includes securing the first end of the curing envelope to the rim, and securing the second end of the curing envelope to the rim.

6. The method of claim 1, wherein the securing of the curing envelope about the elastomeric tread includes securing the first end of the curing envelope to the first disk, and securing the second end of the curing envelope to the second disk.

7. The method of claim 1, wherein the upper diameter of the first disk is equal to the upper diameter of the second disk, and wherein the lower diameter of the first disk is equal to the lower diameter of the second disk.

8. The method of claim 1, wherein the upper diameter of the first disk is equal to the second diameter of the upper ring, and wherein the lower diameter of the first disk is equal to the first diameter of the lower ring.

9. A system for assembling a circumferential tread and a non-pneumatic tire structure having an upper ring, a lower ring, and support structure extending between the upper ring and the lower ring, the system comprising:
a curing envelope dimensioned to receive a non-pneumatic tire structure and a circumferential tread;
a first disk configured to be secured to a first side of the non-pneumatic tire structure;
a second disk configured to be secured to a second side of the non-pneumatic tire structure;
a first fastener configured to secure a first side of the curing envelope to the non-pneumatic tire structure, and
a second fastener configured to secure a second side of the curing envelope to the non-pneumatic tire structure.

10. The system of claim 9, wherein the first disk has a first upper diameter and a first central opening defining a first lower diameter, and wherein the second disk has a second upper diameter and a second central opening defining a second lower diameter.

11. The system of claim 10, wherein the first upper diameter is equal to the second upper diameter, and wherein the first lower diameter is equal to the second lower diameter.

12. The system of claim 9, wherein each of the first disk and the second disk is constructed of a material selected from the group consisting of aluminum, carbon fiber, and a polymeric material.

13. The system of claim 9, wherein the first fastener is an arc band and wherein the second fastener is an arc band.

14. The system of claim 9, wherein the first fastener is configured to secure the first side of the curing envelope directly to the non-pneumatic tire structure, and wherein the second fastener is configured to secure the second side of the curing envelope directly to the non-pneumatic tire structure.

15. The system of claim 9, wherein the first fastener is configured to secure the first side of the curing envelope to a rim, and wherein the second fastener is configured to secure the second side of the curing envelope to the rim.

16. A method of making a non-pneumatic tire, the method comprising:
providing a non-pneumatic tire structure;
providing a first disk and a second disk;
securing the first disk to a first side of the non-pneumatic tire structure;
securing the second disk to a second side of the non-pneumatic tire structure;
providing an elastomeric tread circumferentially about a top of the non-pneumatic tire structure;
securing a curing envelope about the elastomeric tread, including the steps of securing a first end of the curing envelope to the first side of the non-pneumatic tire structure and securing a second end of the curing envelope to the second side of the non-pneumatic tire structure; and
applying heat within the curing envelope.

17. The method of claim 16, further comprising applying pressure within the curing envelope.

18. The method of claim 16, further comprising mounting the non-pneumatic tire structure to a rim.

19. The method of claim 16, wherein the non-pneumatic tire structure includes a lower ring having a first diameter, an upper ring having a second diameter greater than the first diameter, and a support structure extending between the lower ring and the upper ring.

20. The method of claim 16, wherein each of the first and second disks has an upper diameter and a central opening defining a lower diameter.
